(19) United States
(12) Patent Application Publication
(10) Pub. No.: US 2022/0199339 A1
(43) Pub. Date: Jun. 23, 2022

(54) BACKLIGHT KEYBOARD

(71) Applicant: DARFON ELECTRONICS CORP., Taoyuan City (TW)

(72) Inventor: Chao-Yu Chen, Taoyuan City (TW)

(73) Assignee: DARFON ELECTRONICS CORP., Taoyuan City (TW)

(21) Appl. No.: 17/543,696

(22) Filed: Dec. 6, 2021

(30) Foreign Application Priority Data
Dec. 21, 2020 (TW) 109145256

(51) Int. Cl. H01H 13/83; F21V 8/00

(52) U.S. Cl. CPC H01H 13/83; H01H 2219/062; H01H 2209/038; G02B 6/0035

(57) ABSTRACT

A backlight keyboard includes a keyswitch assembly, a base and a light guide plate. The keyswitch assembly and the base are suitable for several language keyboards. A first keyswitch and a second keyswitch of a first keyswitch assembly correspond to a third keyswitch of a second keyswitch assembly. A first base and a second base respectively have at least one hole. The light guide plate has a light guide substrate and a light extracting portion. Union of the holes is set as a difference region on the light guide substrate. The light extracting portion is disposed on the difference region and used to guide light through the corresponding hole toward the corresponding keyswitch when the light guide substrate is disposed under the specific base.

### BACKGROUND OF THE INVENTION

### 1. Field of the Invention

The present invention relates to a backlight keyboard, and more particularly, to a backlight keyboard having a light guide plate suitable for every kind of language family.

### 2. Description of the Prior Art

Please refer to the prior art as recited in the patent U.S. Pat. No. 9,269,509B. A backlight keyboard utilizes a backlight module as a light source. In general, the backlight module includes a light guiding plate, a light emitting unit, and a base. Light emitted by the light emitting unit is guided by a reflection area of the light guiding plate to be emitted out of the backlight keyboard. The base is disposed on the light guiding plate, and has a plurality of hole areas formed thereon corresponding to a plurality of keyswitches on the backlight keyboard for allowing the light to be projected onto symbols on the keyswitches for illumination effect. However, a keyswitch layout on the backlight keyboard may be varied due to setting change of language family (e.g., U.S. language family, U.K. language family or Japanese language family), so that the reflection area of the light guiding plate disposed on the backlight keyboard relevant to one language family is different from the reflection area of another light guiding plate disposed on the backlight keyboard relevant to another language family; it may cause the problem that the light guiding plate cannot be commonly applied to different backlight keyboards with different language families, so as to increase manufacturing cost of the light guiding plate.

### SUMMARY OF THE INVENTION

The present invention provides a backlight keyboard having a light guide plate suitable for every kind of language family for solving above drawbacks.

According to the claimed invention, a backlight keyboard includes a keyswitch assembly, a base and a light guide plate. The keyswitch assembly is a first keyswitch assembly suitable for a first language keyboard or a second keyswitch assembly suitable for a second language keyboard. A first keyswitch and a second keyswitch of the first keyswitch assembly are adjacent to each other, and position of the first keyswitch and the second keyswitch in the first language keyboard is overlapped with position of a third keyswitch of the second keyswitch assembly in the second language keyboard. The base is disposed under the keyswitch assembly, and is a first base suitable for the first language keyboard or a second base suitable for the second language keyboard. The first base has a first hole area and a second hole area respectively corresponding to the first keyswitch and the second keyswitch, and the second base has a third hole area corresponding to the third keyswitch. The light guide plate is adapted to guide a light beam to pass through the base and project onto the keyswitch assembly. The light guide plate includes a light guide substrate and a light extracting portion. The light guide substrate has a difference region, and the difference region is a union of the first hole area, the second hole area and the third hole area. The light extracting portion is disposed on the difference region, and is adapted to guide the light beam to pass through the first hole area and the second hole area and project onto the first keyswitch and the second keyswitch in response to the light guide substrate disposed on the first base, and further guide the light beam to pass through the third hole area and project onto the third keyswitch in response to the light guide substrate disposed on the second base.

The keyboards corresponding to different language families can respectively have the specific keyswitch assembly and the specific base; therefore, the light guide plate of the present invention can set the difference region in accordance with the union of several hole areas between the bases corresponding to different language families, and then dispose the light extracting portion on the difference region for guiding the light beam to the related keyswitch on every kind of keyswitch assemblies. Comparing to the prior art reference, the light guide plate of the present invention can be suitable for the keyboards corresponding to every kind of language family, and illumination intensity and uniformity of a backlight module of the keyboard are not affected, and a halo required by the keyboards corresponding to every kind of language family can be taken into account without light leakage. The light guide plate of the present invention can be compatible with the keyboards applicable to U.K. language family, Japanese language family and U.S. language family, and can preferably shorten a correction period of design change and reduce production and storage cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of one keyswitch of a backlight keyboard according to an embodiment of the present invention.

FIG. 2 is a diagram of a light guide plate according to the embodiment of the present invention.

FIG. 3 is a diagram of the light guide plate applied for a first language keyboard according to the embodiment of the present invention.

FIG. 4 is a diagram of the light guide plate applied for a second language keyboard according to the embodiment of the present invention.

FIG. 5 is an exploded sectional view of the first language keyboard shown in FIG. 3.

FIG. 6 is an exploded sectional view of the second language keyboard shown in FIG. 4.

FIG. 7 is another exploded sectional view of the first language keyboard shown in FIG. 3.

FIG. 8 is another exploded sectional view of the second language keyboard shown in FIG. 4.

FIG. 9 is a top view of the light guide plate applied for a third language keyboard according to the embodiment of the present invention.

### DETAILED DESCRIPTION

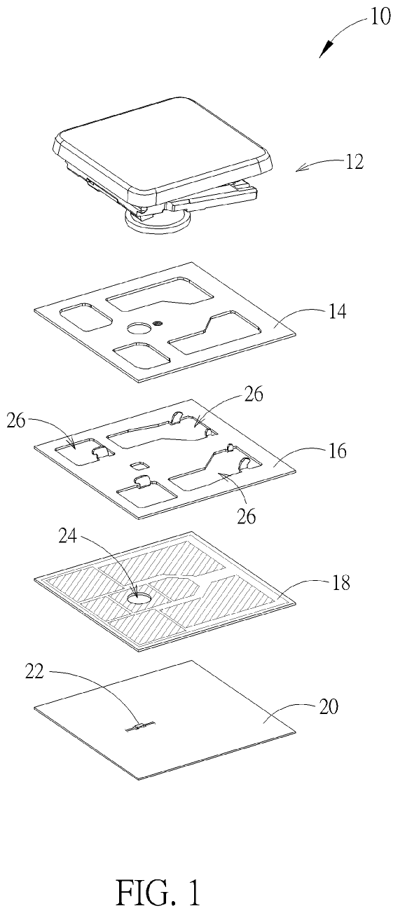

Please refer to FIG. 1. FIG. 1 is an exploded diagram of one keyswitch of a backlight keyboard 10 according to an embodiment of the present invention. The backlight keyboard 10 can be the keyboard relevant to any language family and applied to a desktop computer or a notebook computer. The backlight keyboard 10 can include, but not be limited to, a keyswitch assembly 12, a thin film cirucit board 14, a base 16, a light guide plate 18 and a main circuit board 20. A light unit 22 disposed on the main circuit board 20 can insert into an opening 24 formed on the light guide plate 18. The light guide plate 18 can guide a light beam emitted by the light unit 22 toward a hole 26 formed on the base 16, so as to project onto the keyswitch assembly 12 and illuminate a symbol on each keyswitch of the keyswitch assembly 12.

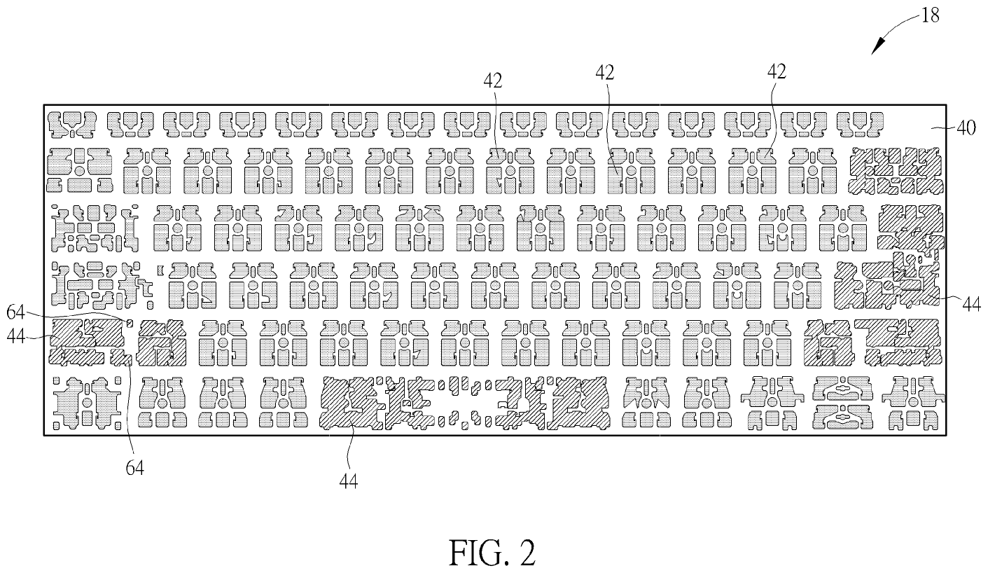

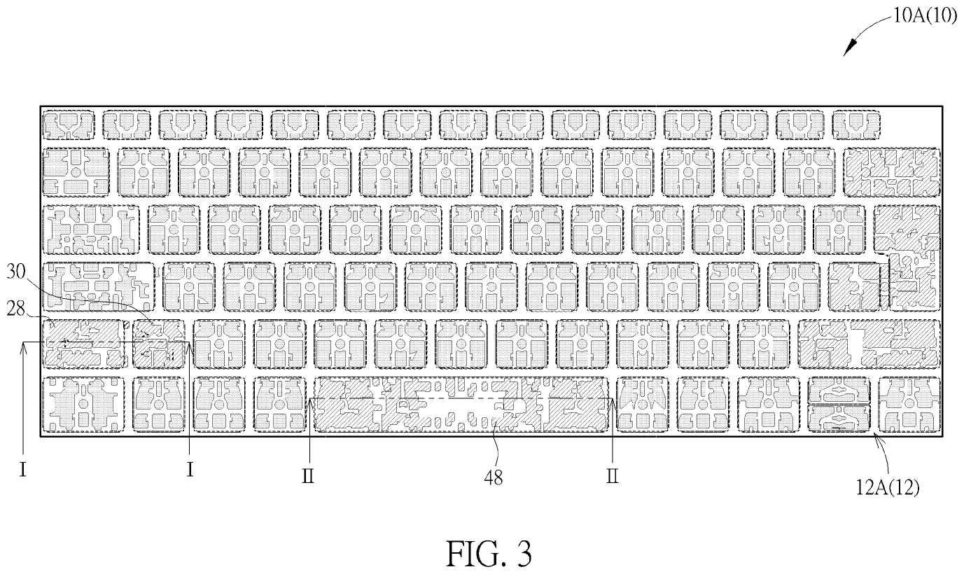

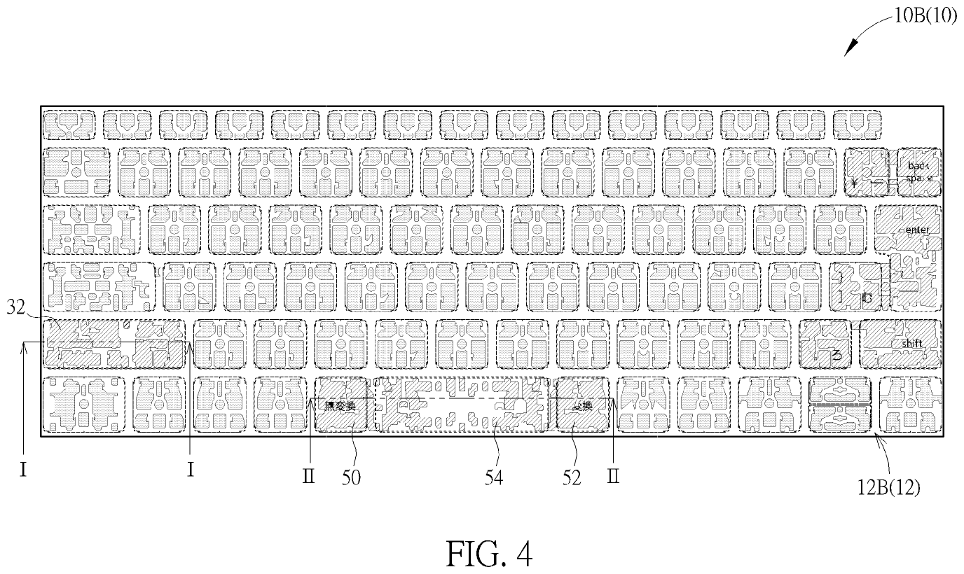

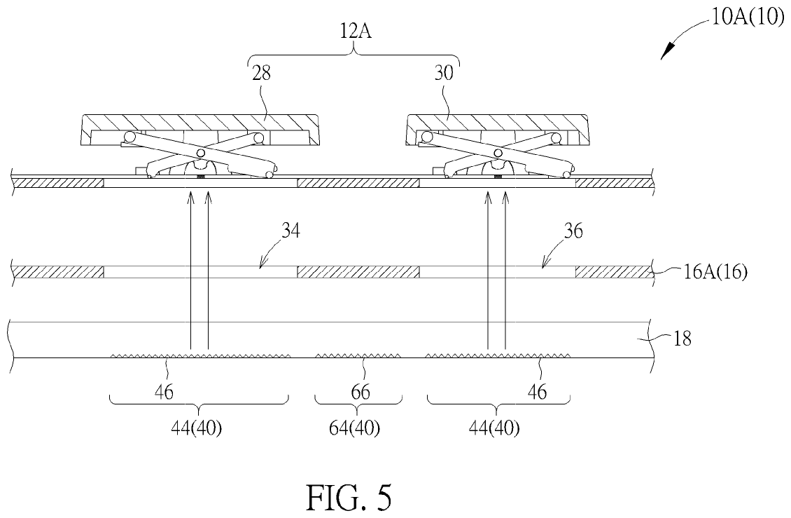

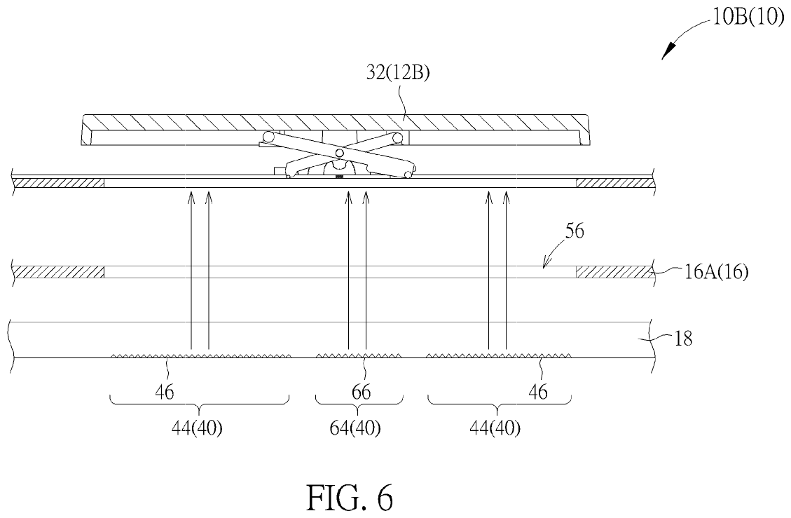

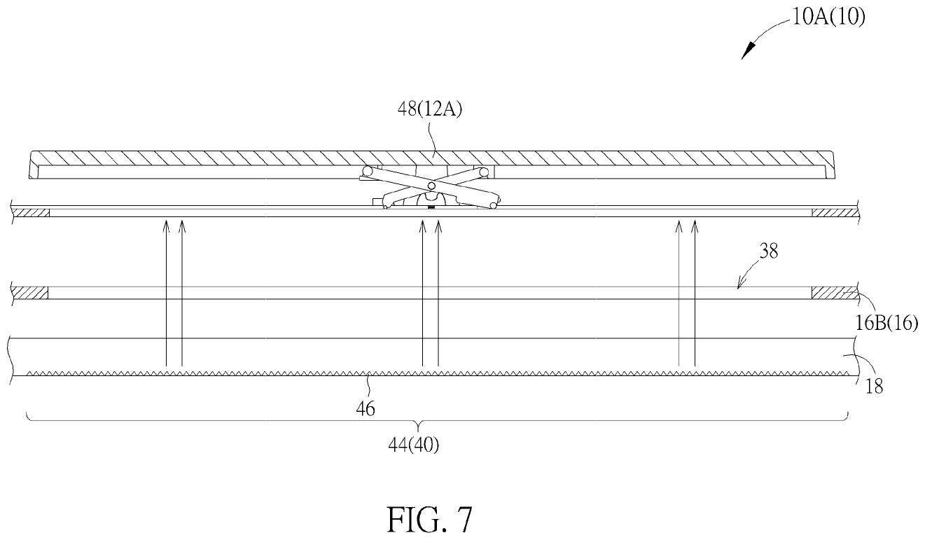

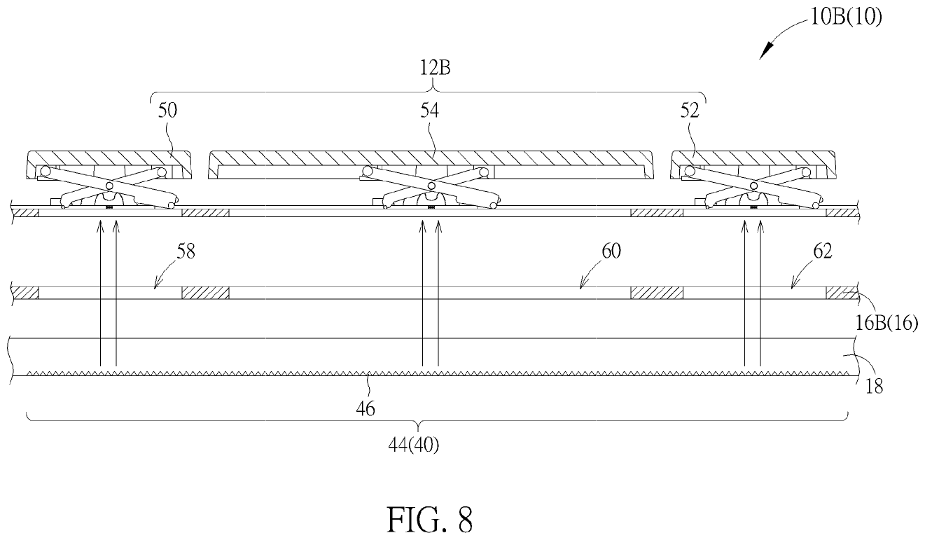

Please refer to FIG. 2 to FIG. 8. FIG. 2 is a diagram of a light guide plate 18 according to the embodiment of the present invention. FIG. 3 is a diagram of the light guide plate 18 applied for a first language keyboard 10A according to the embodiment of the present invention. FIG. 4 is a diagram of the light guide plate 18 applied for a second language keyboard 10B according to the embodiment of the present invention. FIG. 5 is an exploded sectional view of the first language keyboard 10A shown in FIG. 3 along line I-I. FIG. 6 is an exploded sectional view of the second language keyboard 10B shown in FIG. 4 along line I-I. FIG. 7 is an exploded sectional view of the first language keyboard 10A shown in FIG. 3 along line II-II. FIG. 8 is an exploded sectional view of the second language keyboard 10B shown in FIG. 4 along line II-II.

The keyswitch assembly 12 shown in FIG. 1 may be the keyswitch assembly corresponding to any language family; for example, the first keyswitch assembly 12A of the first language keyboard 10A may correspond to U.K. language family, and the second keyswitch assembly 12B of the second language keyboard 10B may correspond to Japanese language family. Position of most keyswitches on the first keyswitch assembly 12A can be the same as position of corresponding keyswitches on the second keyswitch assembly 12B; however, some keyswitches of the first keyswitch assembly 12A may be unmatched with related keyswitches of the second keyswitch assembly 12B due to dimensional difference. For example, position of the first keyswitch 28 and the second keyswitch 30 of the first keyswitch assembly 12A are adjacent to each other in the first language keyboard 10A, and assembly position of the first keyswitch 28 and the second keyswitch 30can be substantially overlapped with position of a third keyswitch 32 of the second keyswitch assembly 12B in the second language keyboard 10B.

When the first language keyboard 10A corresponds to U.K. language family, the first keyswitch 28 can be a keyswitch having a length one and a half times a standard length of a normal keyswitch, and the second keyswitch 30 can be the normal keyswitch with the standard length. A symbol on one of the first keyswitch 28 and the second keyswitch 30 is “ [symbol] ”, and a symbol on another of the first keyswitch 28 and the second keyswitch 30 is “\”. When the second language keyboard 10B corresponds to Japanese language family, the third keyswitch 32 can be a keyswitch having a length two and a half times the standard length of the normal keyswitch, and a symbol on the third keyswitch 32 is “shift”. Symbols on the position-overlapped keyswitches between the keyboards corresponding to different language families are not limited to the above-mentioned embodiment, which depend on a design demand, and a detailed description is omitted herein for simplicity.

The base 16 shown in FIG. 1 can be any base applied for any language family of the keyboard, such as a first base 16A of the first language keyboard 10A corresponding to U.K. language family, or a second base 16B of the second language keyboard 10B corresponding to Japanese language family. The first base 16A can include a plurality of hole areas relevant to all keyswitches of the first keyswitch assembly 12A. The second base 16B can include another plurality of hole areas relevant to all keyswitches of the second keyswitch assembly 12B. Most of the plurality of hole areas on the first base 16A can be the same as the corresponding hole areas on the second base 16B, and some hole areas on the first base 16A may be unmatched with related hole areas on the second base 16B. For example, the first base 16A can include a first hole area 34 and a second hole area 36, respectively corresponding to the first keyswitch 28 and the second keyswitch 30; the second base 16B can include a third hole area 38 corresponding to the third keyswitch 32. Assembly position of the first hole area 34 and the second hole area 36 can be overlapped with single position of the third hole area 38.

A light guide substrate 40 of the light guide plate 18 can include microdots 42, such as dotted areas shown in FIG. 2, disposed on position corresponding to the hole 26 on the base 16. The microdots 42 can destroy total internal reflection of the light guide plate 18 to let the light beam pass through the hole 26 and project onto the keyswitch assembly 12. Arrangement, distribution and density of the microdots 42 can depend on the language family of the keyboard. It should be mentioned that the light guide substrate 40 can further include a difference region 44 disposed on a union of the first hole area 34, the second hole area 36 and the third hole area 38, such as slash areas shown in FIG. 2. A shape, a number and position of the difference region 44 can depend on the union result of several keyboards respectively corresponding to different language families. The light guide plate 18 can further include a light extracting portion 46 disposed on the difference region 44 of the light guide substrate 40. The light extracting portion 46 can guide the light beam to pass through the hole area on the base 16 applied for the keyboard corresponding to any language family.

Therefore, as shown in FIG. 3 and FIG. 5, if the backlight keyboard 10 is the first language keyboard 10A, the light guide plate 18 can be disposed under the first keyswitch assembly 12A and the first base 16A; the light extracting portion 46 on the difference region 44 can guide the light beam to pass through the first hole area 34 and the second hole area 36 on the first base 16A, so as to project onto the first keyswitch 28 and the second keyswitch 30 of the first keyswitch assembly 12A. As shown in FIG. 4 and FIG. 6, if the backlight keyboard 10 is the second language keyboard 10B, the light guide plate 18 can be disposed under the second keyswitch assembly 12B and the second base 16B; the light extracting portion 46 of the difference region 44 can guide the light beam to pass through the third hole area 38 on the second base 16B, so as to project onto the third keyswitch 32 of the second keyswitch assembly 12B.

As shown in FIG. 3 and FIG. 7, some keyswitches of the first keyswitch assembly 12A may have position different from position of related keyswitches of the second keyswitch assembly 12B. For example, position of a fourth keyswitch 48 of the first keyswitch assembly 12A in the first language keyboard 10A can be substantially overlapped with assembly position of a fifth keyswitch 50, a sixth keyswitch 52 and a seventh keyswitch 54 of the second keyswitch assembly 12B in the second language keyboard 10B. The first base 16A can include a fourth hole area 56 corresponding to the fourth keyswitch 48. The second base 16B can include a fifth hole area 58, a sixth hole area 60 and a seventh hole area 62 respectively corresponding to the fifth keyswitch 50, the sixth keyswitch 52 and the seventh keyswitch 54.

The light guide plate 18 can dispose another difference region 44 on position of the light guide substrate 40 relevant to a union of the fourth hole area 56, the fifth hole area 58, the sixth hole area 60 and the seventh hole area 62; the foresaid difference region 44 can include the related light extracting portion 46. As shown in FIG. 3 and FIG. 7, if the backlight keyboard 10 is the first language keyboard 10A, the light guide plate 18 can be disposed under the first keyswitch assembly 12A and the first base 16A; the light extracting portion 46 on the difference region 44 can guide the light beam to pass through the fourth hole area 56 on the first base 16A so as to project onto the fourth keyswitch 48 of the first keyswitch assembly 12A. As shown in FIG. 3 and FIG. 8, if the backlight keyboard 10 is the second language keyboard 10B, the light guide plate 18 can be disposed under the second keyswitch assembly 12B and the second base 16B; the light extracting portion 46 on the difference region 44 can guide the light beam to pass through the fifth hole area 58, the sixth hole area 60 and the seventh hole area 62 on the second base 16B, so as to project onto the fifth keyswitch 50, the sixth keyswitch 52 and the seventh keyswitch 54 of the second keyswitch assembly 12B.

When the first language keyboard 10A corresponds to U.K. language family, the fourth keyswitch 48 can be a keyswitch having a length five times the standard length of the normal keyswitch and be a space key. When the second language keyboard 10B corresponds to Japanese language family, the fifth keyswitch 50 and the sixth keyswitch 52 are the normal keyswitch, and the seventh keyswitch54 can be a keyswitch having a length three times the standard length of the normal keyswitch, and one of the fifth keyswitch 50, the sixth keyswitch 52 and the seventh keyswitch 54 can be the space key. Symbols on the position-overlapped keyswitches between the keyboards corresponding to different language families are not limited to the above-mentioned embodiment, which depends on the design demand, and the detailed description is omitted herein for simplicity.

In other possible embodiment, some keyswitch may have the longer length. The difference region 44 and the light extracting portion 46 disposed on the light guide substrate 40 of the light guide plate 18 may be difficult to cover the foresaid keyswitch that has greater structural dimensions, such as the fourth keyswitch 48, in accordance with the union result of the several hole areas between the first base 16A and the second base 16B of the related keyboards corresponding to different language families. In the present invention, the backlight keyboard 10 may optionally dispose an auxiliary difference region 64 on the light guide substrate 40, such as the slash areas shown in FIG. 2. Position of the auxiliary difference region 64 does not correspond to the hole area on the first base 16A and/or the second base 16B, but corresponds to position of a middle between the hole areas, such as position between the first hole area 34 and the second hole area 36. The light guide plate 18 can further dispose an auxiliary light extracting portion 66 on the auxiliary difference region 64, and the auxiliary light extracting portion 66 can enhance or resupply intensity of the light beam projected onto the specific keyswitch.

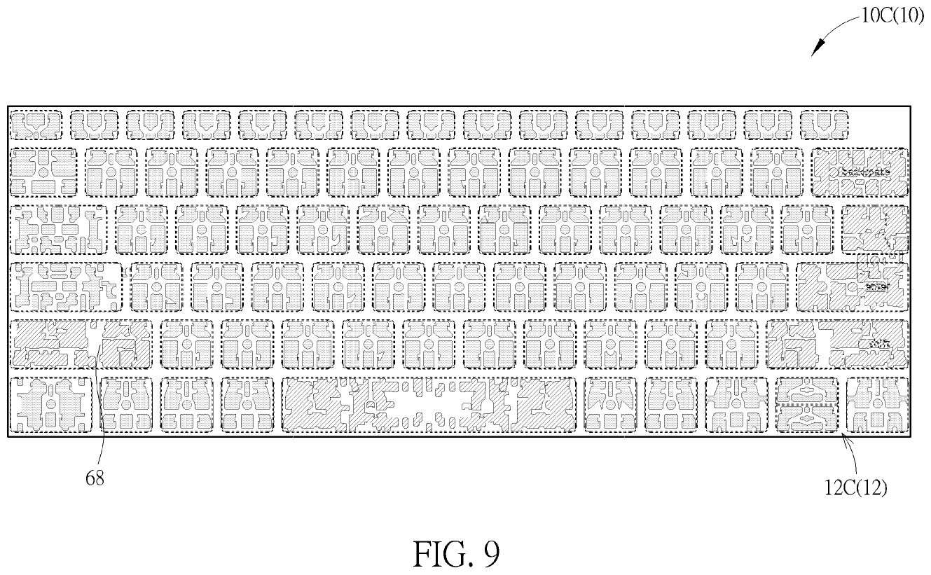

Please refer to FIG. 9. FIG. 9 is a top view of the light guide plate 18 applied for a third language keyboard 10C according to the embodiment of the present invention. The third language keyboard 10C can correspond to U.S. language family. A third keyswitch assembly 12C of the third language keyboard 10C can include an eighth keyswitch 68, and position of the eighth keyswitch 68 can be substantially overlapped with assembly position of the first keyswitch 28 and the second keyswitch 30 of the first keyswitch assembly 12A, or position of the third keyswitch 32 of the second keyswitch assembly 12B. A third base of the third language keyboard 10C can include an eighth hole area corresponding to the eighth keyswitch 68; the third base and the eighth hole area are not marked in the figures. The difference region 44 can be relevant to the union of the first hole area 34, the second hole area 36, the third hole area 38 and the eighth hole area. If the light guide plate 18 is applied for the third language keyboard 10C, the light extracting portion 46 on the difference region 44 can guide the light beam to pass through the eighth hole area on the third base so as to project onto the eighth keyswitch 68 of the third keyswitch assembly 12C.

Therefore, the keyboards corresponding to different language families can respectively have the specific keyswitch assembly and the specific base; therefore, the light guide plate of the present invention can set the difference region in accordance with the union of several hole areas between the bases corresponding to different language families, and then dispose the light extracting portion on the difference region for guiding the light beam to the related keyswitch on every kind of keyswitch assemblies. Comparing to the prior art reference, the light guide plate of the present invention can be suitable for the keyboards corresponding to every kind of language family, and illumination intensity and uniformity of a backlight module of the keyboard are not affected, and a halo required by the keyboards corresponding to every kind of language family can be taken into account without light leakage. The light guide plate of the present invention can be compatible with the keyboards applicable to U.K. language family, Japanese language family and U.S. language family, and can preferably shorten a correction period of design change and reduce production and storage cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight keyboard comprising:
a keyswitch assembly being a first keyswitch assembly suitable for a first language keyboard or a second keyswitch assembly suitable for a second language keyboard, a first keyswitch and a second keyswitch of the first keyswitch assembly being adjacent to each other, position of the first keyswitch and the second keyswitch in the first language keyboard being overlapped with position of a third keyswitch of the second keyswitch assembly in the second language keyboard;
a base disposed under the keyswitch assembly and being a first base suitable for the first language keyboard or a second base suitable for the second language keyboard, the first base having a first hole area and a second hole area respectively corresponding to the first keyswitch and the second keyswitch, and the second base having a third hole area corresponding to the third keyswitch; and
a light guide plate adapted to guide a light beam to pass through the base and project onto the keyswitch assembly, the light guide plate comprising:
a light guide substrate having a difference region, the difference region being a union of the first hole area, the second hole area and the third hole area; and
a light extracting portion disposed on the difference region and adapted to guide the light beam to pass through the first hole area and the second hole area and project onto the first keyswitch and the second keyswitch in response to the light guide substrate disposed on the first base, and further guide the light beam to pass through the third hole area and project onto the third keyswitch in response to the light guide substrate disposed on the second base.

2. The backlight keyboard of claim 1, wherein the first keyswitch assembly corresponds to U.K. language family, the second keyswitch assembly corresponds to Japanese language family.

3. The backlight keyboard of claim 2, wherein a symbol on one of the first keyswitch and the second keyswitch is “¹”, and a symbol on the third keyswitch is “shift”.

4. The backlight keyboard of claim 1, wherein the first keyswitch assembly further comprises a fourth keyswitch, position of the fourth keyswitch in the first language keyboard is overlapped with position of a fifth keyswitch, a sixth keyswitch and a seventh keyswitch of the second keyswitch assembly in the second language keyboard, the light extracting portion corresponds to the fourth keyswitch, the fifth keyswitch, the sixth keyswitch and the seventh keyswitch so as to guide the light beam to project onto the fourth keyswitch, the fifth keyswitch, the sixth keyswitch and the seventh keyswitch.

5. The backlight keyboard of claim 4, wherein the fourth keyswitch is a space key, and one of the fifth keyswitch, the sixth keyswitch and the seventh keyswitch is the space key.

6. The backlight keyboard of claim 1, wherein the light guide substrate further has an auxiliary difference region, position of the auxiliary difference region corresponds to position of a middle between the first hole area and the second hole area, and the light guide plate further comprises an auxiliary light extracting portion disposed on the auxiliary difference region.
